(19) United States
(12) Patent Application Publication
(10) Pub. No.: US 2011/0147329 A1
(43) Pub. Date: Jun. 23, 2011

(54) LOAD TRANSPORTATION SYSTEM

(76) Inventors: Ian Evans, Hartlepool (GB); Jonathan Harbron, Middlesborough (GB); John Fuller, Leamington Spa (GB)

(21) Appl. No.: 12/865,591

(22) PCT Filed: Jan. 6, 2009
(86) PCT No.: PCT/GB09/50005

§ 371 Date: Dec. 3, 2010

(30) Foreign Application Priority Data
Feb. 6, 2008 (GB) 0802093.5

(51) Int. Cl. B66C 23/22; E04G 21/16; B66D 1/00; B66C 23/20; B23P 11/00

(52) U.S. Cl. 212/179; 254/266; 29/428

(57) ABSTRACT

The invention relates to a high-efficiency load transportation system for use in the building construction industry. The system utilises a hoisting apparatus (18) installed in an upper story of a building (14) and at least one retractable loading platform (20) removably installable on an underlying storey such that it may extend beyond an edge of the floor of the underlying storey. An arm (24) of the hoisting apparatus may extend beyond a distal end of a retracted underlying loading platform to allow the unimpeded vertical lifting and/or lowering of loads beyond the platform. The hoisting apparatus is used to position each loading platforms on its underlying and reposition each loading platform thereafter. Such an arrangement yields significant reductions in load in/load out times and associated costs. The system also reduces the carbon footprint of the building project by reducing traditional tower crane usage.

The present invention relates to a load transportation system and particularly, but not exclusively, to a high efficiency self-contained load transportation system for use in the building construction industry.

Inherent in the construction industry is the use of powered lifting apparatus to move heavy loads, such as building materials, tools and the like around a building site. In the construction of multi-level buildings, several options are available for the vertical transportation of loads to/from ground level and/or between different storeys of the building. Three of the most common options include tower cranes, scaffold hoists and mast climbers, each of which are optionally used in combination with various cantilevered or scaffold mounted platform arrangements to facilitate the movement of the loads into and out of the footprint of the building structure.

Tower cranes typically provide the best combination of weight lifting capacity, height and reach. However, over-dependence on tower cranes can bring significant disadvantages from a practical, cost and environmental perspective. In practical and cost terms, a high dependency on tower cranes by different parts of a busy building site leads to extended on-site waiting times per unit load to be lifted which consequently increases overall build time and adversely affects overall build costs. In addition, tower crane operation is entirely weather condition dependent and unavailability on this basis can often exceed 20% of the total build time. The need for skilled personnel to operate tower cranes is a further overhead which contributes to overall operating costs in the region of £4,000 per week or more. From an environmental standpoint, tower cranes use large amounts of energy to move loads thus constituting a significant proportion of a building project's carbon footprint.

Whilst alternatives such as mast climbers and scaffold hoists can be used to reduce the dependency on tower cranes, these options are also disadvantageous in a number of respects. For example, they are each relatively complex to install and inevitably cause damage to the exterior fabric of the building thus requiring repair work to be carried out upon their removal. Like tower cranes, they each require skilled personnel for their operation and their external footprint to the building being constructed may preclude their use in highly urbanised city centre sites. Their inherently lower load carrying capacity relative to tower cranes mean larger loads must be subdivided into smaller more manageable sizes thus leading to multiple loading cycles, increased loading time, and therefore increased operating costs.

According to a first aspect of the present invention, there is provided a load transportation system for use in the building construction industry comprising:
a hoisting apparatus removably installable within an upper storey of multi-storey building under construction and braced in position against the internal building structure; and
at least one loading platform removably installable on an underlying storey, the loading platform being installable for movement between an extended position in which a distal end thereof extends beyond the edge of a floor of the underlying storey, and a retracted position;
wherein the hoisting apparatus is installable within the building such that an arm thereof is extendable out of the building laterally beyond the distal end of the underlying loading platform when it is in its retracted position to allow the unimpeded vertical lifting and/or lowering of loads beyond the loading platform; and
wherein the or each loading platform is initially positionable on the underlying storey by the hoisting apparatus and is thereafter repositionable to another storey by the hoisting apparatus.

Preferably, the hoisting apparatus comprises a jacking means to brace it in position against the floor and ceiling respectively of the internal building structure.

The jacking means is telescopically integrated within the hoisting apparatus and allows it to be quickly and easily installed on a temporary basis at any position within a building under construction having opposed floors and ceilings. The reaction loads experienced by the hoisting apparatus are conveniently absorbed by the building structure itself without the need for any counterbalancing weights.

Preferably, the loading platform is a rolling platform.

For example, an appropriate rolling platform which is fully retractable to be level with the edge of a floor of the building under construction is disclosed in the applicant's European Patent No. EP 1 392 939B.

Preferably, the hoisting apparatus is provided with a telescopically extendable winch arm.

Preferably, the winch arm is telescopically extendable.

Preferably, the winch arm has a maximum reach of at least 6.0 m from the edge of the floor.

The actual extent to which the winch arm extends beyond the edge of the floor will depend upon a number of factors including, but not limited to: (i) the dimensions of the load to be lifted and/or lowered; (ii) any space constraints arising due to surrounding structures; and (iii) the extent to which underlying loading platforms are retractable.

Preferably, the hoisting apparatus has a Safe Working Load (SWL) of at least 3,000 kg.

A three tonne SWL allows the hoisting apparatus to transport a larger proportion of typical construction site loads. Importantly, this order of lifting capacity is sufficient to allow the hoisting apparatus to lift loading platforms.

Preferably, the maximum lifting height of the hoisting apparatus is at least 120 m.

Lifting heights of this order allow the hoisting apparatus to be positioned multiple storeys above the underlying loading platform(s). Importantly, such an arrangement allows the underlying loading platforms to be progressively elevated to higher storeys by the hoisting apparatus as building work progresses, but without the need to also elevate the hoisting apparatus each time. The hoisting apparatus itself need only be repositioned to a higher storey once the loading platforms “catch up”.

Preferably, the maximum lifting speed of the hoisting apparatus is at least 25 m per minute.

Lifting speeds of this order are significantly quicker than scaffold hoists and mast climbers.

According to a second aspect of the present invention, there is provided a method of installing a load transportation system for use in the building construction industry, the method comprising the steps of:
(i) lifting a loading platform to an upper storey of a building under construction where a hoisting apparatus is to be installed;
(ii) temporarily installing the loading platform on said upper storey;
(iii) lifting a hoisting apparatus onto the loading platform;
(iv) moving the hoisting apparatus into the storey of the building and bracing it in position against the building structure;
(v) detaching the loading platform from the upper storey and lowering it to an underlying storey;
(vi) removably installing the loading platform on the underlying storey such that it is moveable between an extended position in which it can extend beyond the edge of a floor of the underlying storey, and a retracted position.

Preferably, steps (i) and (iii) and (v) are performed by a tower crane.

Advantageously, tower crane involvement is restricted to steps (i) and (iii) and (v) of the method since the hoisting apparatus is itself capable of lifting and/or lowering any further loading platforms once it has been installed within the building structure.

Preferably, the method comprises the further step of using the hoisting apparatus to lift one or more further such loading platforms to one or more further underlying storeys and removably installing them thereon.

Loading platforms can be employed on all underlying storeys if required. Alternatively, loading platforms can be used only on selected storeys of the building on the basis of need in order to reduce costs.

Optionally, the method comprises the additional steps of detaching a loading platform from the underlying storey; using the hoisting apparatus to lift it to another underlying storey not having a loading platform; and removably reinstalling the loading platform on the new underlying storey.

In practice, it is unlikely that each underlying floor will be provided with its own loading platform. This is because building work typically advances in stages progressively up through a building and so it is more cost efficient to employ loading platforms at selected storeys on the basis of where building work is actually taking place. Accordingly, assuming that the hoisting apparatus and the loading platform being repositioned are initially spaced by several storeys then such an arrangement allows the underlying loading platforms to be progressively elevated to higher storeys by the hoisting apparatus as building work progresses, but without the need to also elevate the hoisting apparatus each time. The hoisting apparatus itself need only be repositioned to a higher storey once the loading platforms “catch up”.

According to a third aspect of the present invention, there is provided a method of removing a load transportation system installed in accordance with the second aspect, the method comprising the steps of:
(i) attaching the hoisting apparatus to a loading platform on an underlying storey;
(ii) detaching the loading platform from the underlying storey;
(iii) using the hoisting apparatus to lower the loading platform to ground level;
(iv) repeating steps (i) to (iii) as required for all remaining underlying loading platforms;
(v) lifting a loading platform to the upper storey of the building where the hoisting apparatus is installed;
(vi) temporarily installing the loading platform on said upper storey;
(vii) releasing the hoisting apparatus from its braced position and moving it onto the loading platform;
(viii) lifting the hoisting apparatus from the loading platform and lowering it to ground level;
(ix) detaching the loading platform from the upper storey; and
(x) lowering the loading platform to ground level.

Preferably, steps (v), (viii) and (x) are performed by a tower crane.

Embodiments of the present invention will now be described, by way of example only, with reference to the accompanying drawings, in which:

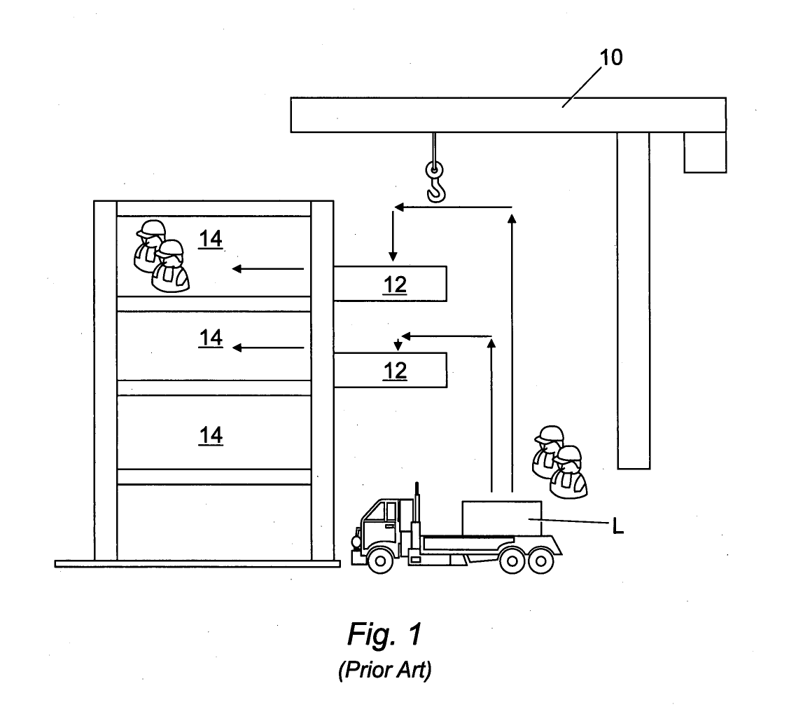

FIG. 1 shows a diagram prior art method of moving loads into a building under construction having a high tower crane dependency;

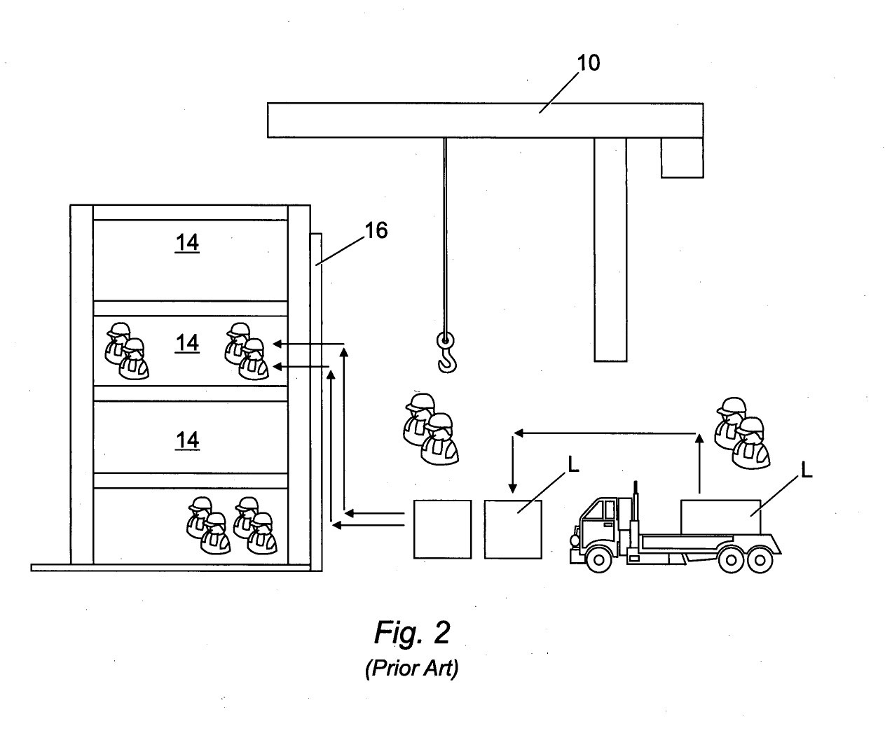

FIG. 2 shows a diagram of a scaffolding or mast climber dependant prior art method of moving loads into a building under construction;

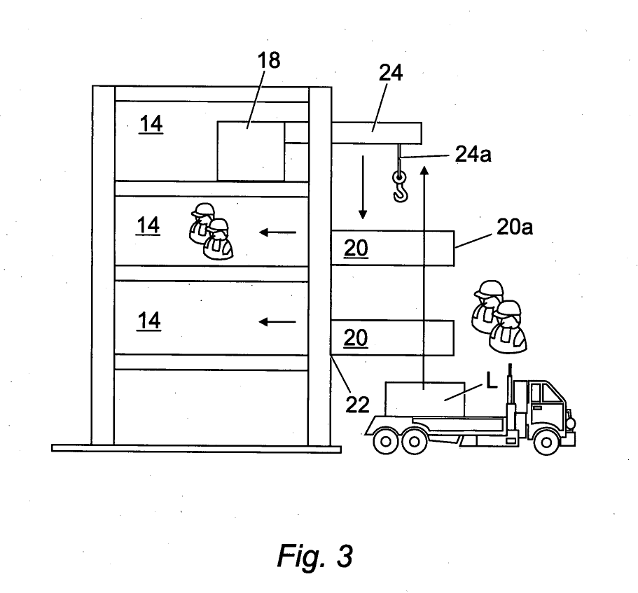

FIG. 3 shows a diagram of a high efficiency self-contained load transportation system in accordance with the present invention;

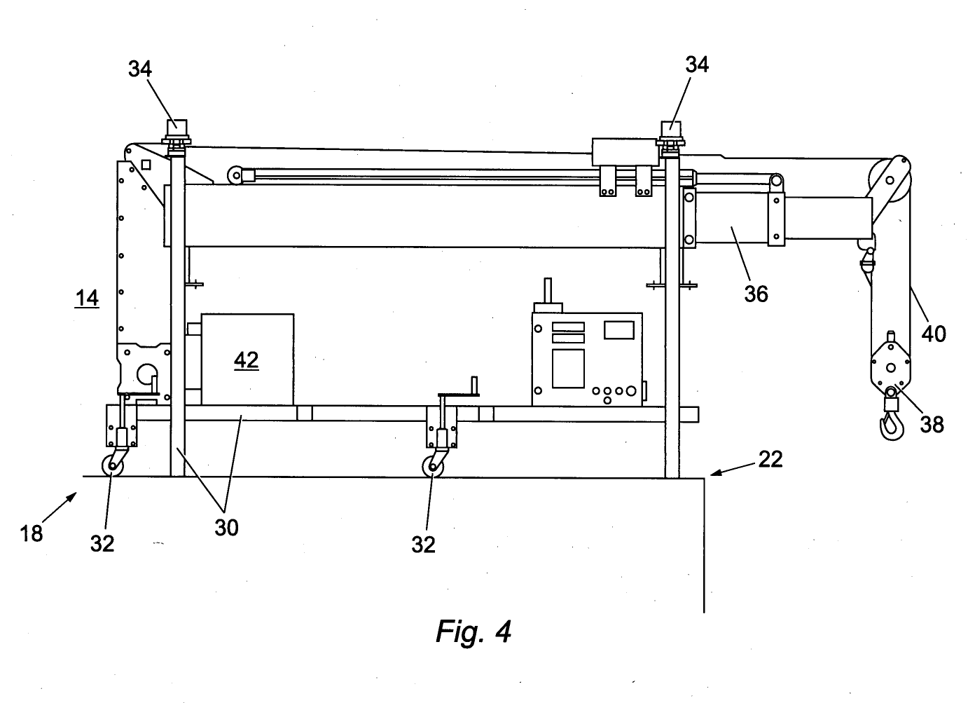

FIG. 4 shows a schematic side view of a hoisting apparatus used in the present invention;

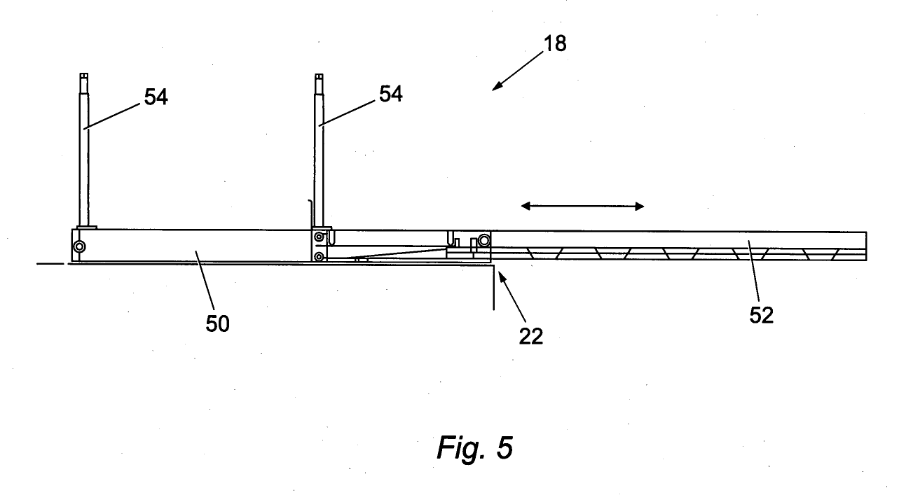

FIG. 5 shows a schematic side view of a retractable loading platform used in the present invention;

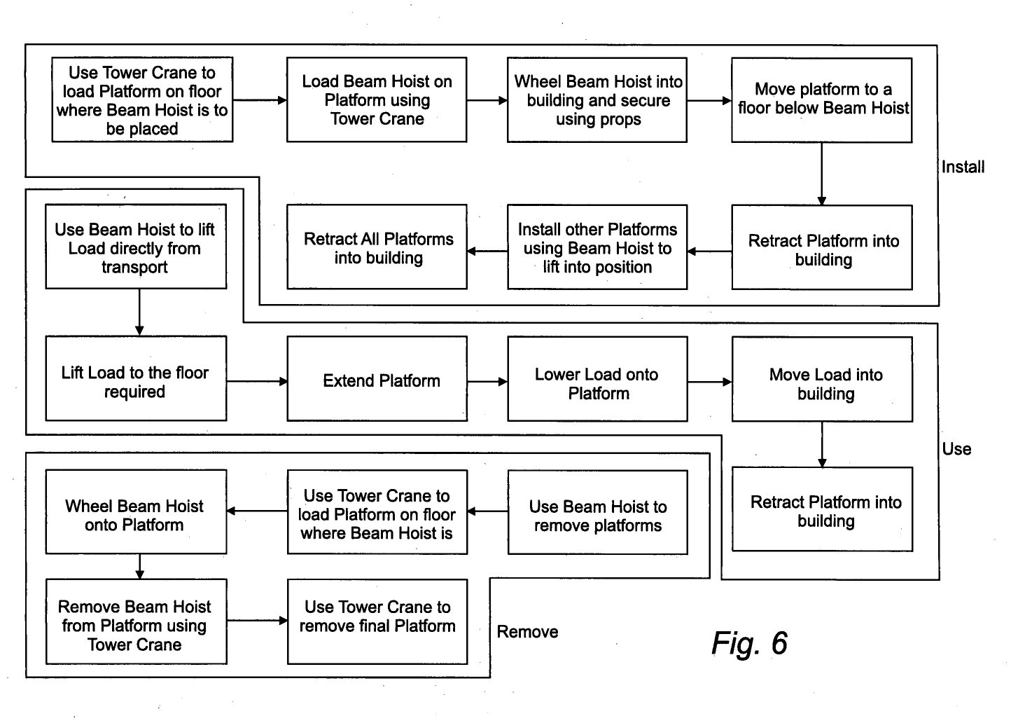

FIG. 6 is a chart showing the steps involved in installation, use and removal of the high efficiency self-contained load transportation system of the present invention; and

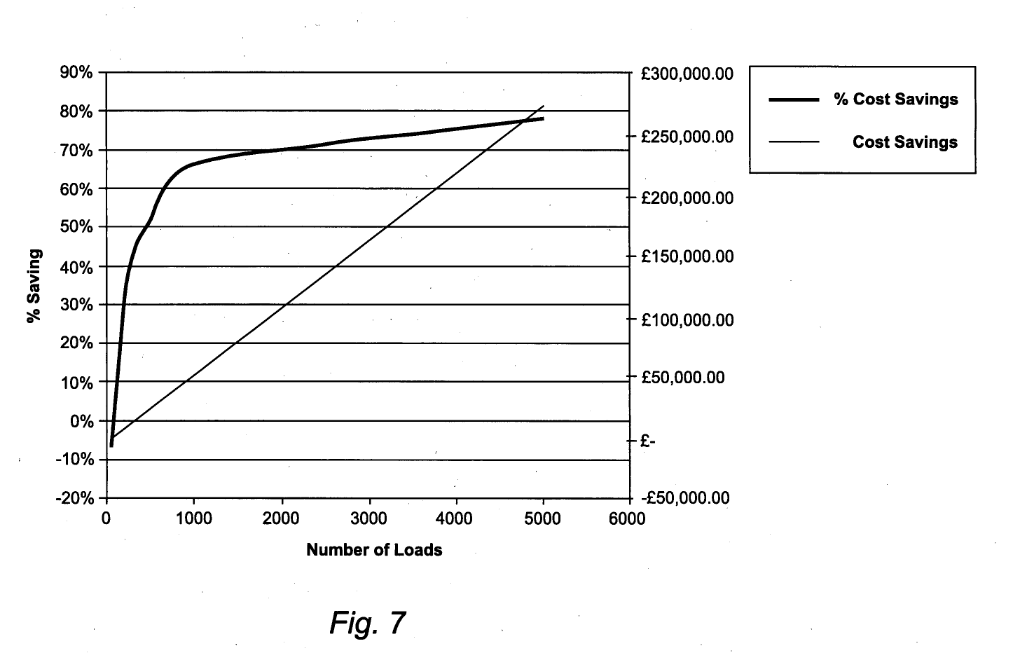

FIG. 7 is a graph showing actual and percentage costs savings per number of loads when using the load transportation system of the present invention in preference to mast climbers or scaffold hoists.

It is known to use loading platforms to facilitate the transportation of loads into a storey of a multi-level building being constructed. A schematic illustration of loading platforms in use is shown in FIG. 1 whereby loads (L) lifted by a tower crane (10) are deposited on a platform (12) located at an appropriate storey (14) of a building being constructed. The loads (L) are then manually moved into and out of the footprint of the building. An improved arrangement is known whereby the loading platforms (12) are each independently retractable within a storey (14) of a building to improve access to each platform (12). Each platform (12) is aligned vertically such that the uppermost platform(s) (12) must be retracted by a distance sufficient to allow unimpeded access to the underlying platform(s) (12) by the tower crane (10). Examples of retractable rolling platforms suitable for this purpose are disclosed in the applicant's European Patent No. EP 1 392 939B and are therefore not described in detail herein. Load transportation systems of this type suffer from being entirely dependent on expensive tower cranes for their operation.

FIG. 2 is a schematic illustration of known mast climber or scaffold hoist apparatus, each of which require a supporting structure (16) to be attached outside the footprint of the building on its exterior wall. Although the lifting of loads to an upper storey (14) is performed by the mast climber or scaffold hoist apparatus, a tower crane (10) is still required to unload materials and deposit them at the base of the building ready for subsequent lifting by the mast climber or scaffold hoist apparatus. Such a system therefore slows the loading process and requires additional manpower at ground level.

FIG. 3 shows a diagram of a high efficiency self-contained load transportation system in accordance with the present invention. A hoisting apparatus (18) is removably installed (as discussed in further detail below) within an upper storey (14) of a building under construction and is braced in position within the upper storey (14) by a jacking means (not shown) extending between the floor and ceiling of the storey (14). An example of a hoisting apparatus (18) is shown in more detail in FIG. 4. It will be appreciated that the term “upper storey” does not necessarily mean the uppermost storey. Indeed, the uppermost storey may change over time as new storeys are progressively created as the building is constructed.

Two retractable loading platforms (20) are removably installed (as discussed in further detail below) in the two underlying storeys (14) in vertical alignment with the hoisting apparatus (18). An example of a retractable loading platform (20) is shown in more detail in FIG. 5. It will be appreciated that any number of retractable loading platforms (20) may be employed depending upon the number of underlying storeys (14).

Equally, some (14) storeys may not require a loading platform (20) and so it is not necessary for every underlying storey (14) to simultaneously have a loading platform (20) installed. Each loading platform (20) is moveable between an extended position in which a distal end (20a) thereof extends beyond the edge (22) of the floor, and a retracted position. Similarly, a telescopic hydraulic arm (24) of the hoisting apparatus (18) can extend out of the footprint of the building, typically up to 6 m beyond the edge (22) of the floor.

In use, each loading platform (20) is retracted, at least to the extent that its distal end (20a) allows a winch (24a) suspended from the telescopic hydraulic arm (24) to be lowered past it, and subsequently allows a load (L) to be lifted above it without being impeded. Ideally, each loading platform (20) is fully retractable to a point where its distal end (20a) lies at, or inwardly beyond, the edge (22) of the floor. Once the load (L) is lifted above the destination storey (14), the appropriate loading platform (20) is extended out of the footprint of the building and locked in position ready to receive the load (L). Once the load (L) is deposited onto the loading platform (20) it is then moved into the building. Conveniently, loads (L) can be lifted directly from a transport vehicle positioned substantially vertically beneath the hoisting apparatus (18) such that tower crane involvement is rendered largely unnecessary (other than as described below). The reduction in tower crane involvement is not only beneficial in terms of cost, but is also less prone to adverse weather conditions. Furthermore, the reduction in tower crane usage also serves to reduce the overall carbon footprint of the construction project. The entire load transportation process is summarised in the chart in FIG. 6 and can be completed without the need for highly skilled personnel thus contributing to reduced cost overheads.

A major advantage of the load transportation system of the present invention is that expensive tower crane involvement is minimised not only during active use of the system but also during its installation and removal. For example, installation of the system involves the preliminary step of temporarily installing a loading platform for the purpose of loading the hoisting apparatus into the appropriate upper storey of the building. Once the hoisting apparatus is moved into the storey of the building the loading platform can be removed (and optionally relocated at an underlying storey). These are the only two stages of the installation process which require tower crane involvement. The subsequent optional steps of installing further loading platforms at other underlying storeys can all be performed by the hoisting apparatus itself as indicated in the chart in FIG. 6.

Similarly, upon removal of the system, the hoisting apparatus can be used to remove all underlying loading platforms. Tower crane usage is therefore restricted to the lifting of a loading platform to the storey where the hoisting apparatus is located, subsequently removing the hoisting apparatus from that loading platform and lowering it to ground level, and finally lowering the loading platform to ground level. The removal process is also summarised in the chart in FIG. 6.

A further particularly advantageous aspect of the load transportation system of the present invention is that its hoisting apparatus (18) is capable of relocating loading platforms (20) to new storeys of the building without the assistance of a tower crane. Usually, this will involve moving loading platforms to higher storeys (14) as work progresses up through a building being constructed. If new storeys (14) are constructed after the initial installation of the hoisting apparatus (18) then relocation of the hoisting apparatus itself may be required. However, if the hoisting apparatus (18) and the underlying loading platforms (20) are initially spaced by multiple storeys (14), then several relocations of the loading platforms will be possible before the hoisting apparatus (18) itself must be relocated to a higher storey (14).

FIG. 4 shows a detailed view of a hoisting apparatus (18) of the present invention which, preferably, has a safe working load (SWL) of at least 3,000 kg. The hoisting apparatus (18) comprises a supporting frame (30) supported on wheels (32) to allow the apparatus to be positioned at an appropriate location within a storey of a building, and to allow its movement to/from a loading platform during its installation and removal. The total footprint of the hoisting apparatus (length×width) is 3.7 m×2.35 m. The apparatus is approximately 2.4 m in height and comprises a telescopic jacking means (34) connected to upper and lower distal ends of upright portions of the supporting frame. The dimensions of the hoisting apparatus are chosen to facilitate the bracing of the hoisting apparatus (18) against the floor and ceiling of the storey within which it is located thus acting to distribute reaction loads through the structure of the building during use. A hydraulic arm (36) is connected to the supporting frame (30) and is telescopically extendable up to a distance of at least 6.0 m. The distal end of the arm (36) supports a hook block (38) at the end of a winch (40). An electrically powered control means (42) controls the operation of the hoisting apparatus (18) and facilitates winch line speeds of up to 25 m per minute with a maximum power consumption of 37 kW. This compares very favourably to a tower crane which has a typical maximum power consumption of 249 kW.

FIG. 5 shows a detailed view of a retractable loading platform (18) of the present invention. The loading platform (18) comprises a static frame (50) for fixing to the floor of a storey of a building and a moveable platform (52) attached thereto for rolling movement between extended and retracted positions. The particular view of FIG. 5 shows the loading platform (18) in its extended position whereby the moveable platform (52) lies laterally beyond the edge (22) of the floor of the storey. Upright members (54) are connected to the static frame (50) and used to brace the loading platform (18) against the floor and ceiling of the storey within which it is located.

The following tabulated information provides a comparison between traditional load transportation systems and the system of the present invention. It considers practical process issues and compares them according to elapsed process time along with the estimated associated costs for each loading system. The effects of the following issues are taken into account:
One off costs
   Design time
   Temporary works including scaffolding
   Removal of temporary works and remedial work
   Installation and removal
Ongoing costs
   Rental
   Load Movement costs
   Loading times
   Manning

Estimated % Cost Savings of the loading system of the
present invention compared to:-

| | Traditional | Mast | |
|---|---|---|---|
| Number of | Cantilever | Climber/Scaffold | Scaffold |
| Loads | Platform (%) | Hoist (%) | Platform (%) |
| 250 | 37 | 36 | −4 |
| 500 | 54 | 51 | 17 |
| 1000 | 66 | 66 | 35 |
| 5000 | 78 | 78 | 56 |

Estimated Cost Savings (£000's) compared to:-

| | Traditional | Mast | |
|---|---|---|---|
| Number of | Cantilever | Climber/Scaffold | Scaffold |
| Loads | Platform | Hoist | Platform |
| 250 | 10 | 10 | −1 |
| 500 | 24 | 24 | 4 |
| 1000 | 52 | 51 | 14 |
| 5000 | 272 | 272 | 96 |

Estimated Number Of Load outs Possible per 40 hour week

| | Load Out Capability | | | |
|---|---|---|---|---|
| | | Traditional | | |
| | Present | Cantilever | Mast Climber/ | Scaffold |
| | invention | Platform | Scaffold Hoist | Platform |
| Per 40 hour | 200 | 75 | 31 | 71 |
| week | | | | |

The foregoing analysis assumes a fixed 17 week hire period for all types of systems. By using the load transportation system of the present invention, significant reductions in load in/out time can be achieved, together with an associated reduction in costs. Whilst the savings over a scaffold platform are more modest, there are still substantial gains to be achieved if the system requires to be relocated during the hire period. Indeed, in all cases, if the load in/out location needs to be relocated, the load transportation system of the present invention is significantly more cost and time effective. A graph of the cost savings to be enjoyed mast climber and scaffold hoist systems per number of loads is shown in FIG. 7.

The following table provides a more detailed comparison of the system of the present invention and traditional systems.

| | Present | Scaffold | | Scaffold |
|---|---|---|---|---|
| | Invention | Hoist | Mast Climber | Platform |
| SWL Capacity | <=3 | <2 | <2 | >8 |
| (tonnes) | | | | |
| Footprint | Within building | External | External | External |
| Installation | No permanent | Structural | Structural | Structural |
| | structural tie in | rework needed | rework needed | rework needed |
| | to repair at end | | | |
| Utilisation | Material Only | Shared | Usually people | Shared |
| | | | only | |
| Positioning | Relocatable | Fixed | Fixed | Fixed |
| Loading area | Up to 2.9 m | Limited/Small | Limited/Small | Small |
| | width | | | |
| Operator | Low skill | Skilled | Skilled | None |
| requirement | | | | |
| Design cost | Low | High | High | Medium |
| Running cost | Low | Expensive | Expensive | Low |
| Complexity | Low | High | High | Med |
| Usage | Dedicated | Multiple | Multiple | Dedicated |

Modifications and improvements may be made to the foregoing without departing from the scope of the present invention. For example, the loading platform (18) may be provided with a damped means towards the end of its retracting motion to avoid imparting unnecessary shocks to the load (L). An automatic ramp mechanism may also be provided at the internal distal end of the loading platform (18) to facilitate a smooth transition to the floor of the storey. The jacking means of the hoisting apparatus may be self-jacking

1. A load transportation system for use in the building construction industry comprising:
a hoisting apparatus removably installable within an upper storey of multi-storey building under construction and braced in position against the internal building structure;
at least one loading platform removably installable on an underlying storey, the loading platform being installable for movement between an extended position in which a distal end thereof extends beyond the edge of a floor of the underlying storey and a retracted position; and
wherein the hoisting apparatus is installable within the building such that an arm thereof is extendable out of the building laterally beyond the distal end of the underlying loading platform when it is in its retracted position to allow the unimpeded vertical lifting and/or lowering of loads beyond the loading platform; and wherein the or each loading platform is initially positionable on the underlying storey by the hoisting apparatus and is thereafter repositionable to another storey by the hoisting apparatus.

2. A load transportation system as claimed in claim 1, wherein the hoisting apparatus comprises a jacking means to brace it in position against the floor and ceiling respectively of the internal building structure.

3. A load transportation system as claimed in claim 1, wherein the loading platform is a rolling platform.

4. A load transportation system as claimed in claim 1, wherein the hoisting apparatus and the or each loading platform are in vertical alignment.

5. A load transportation system as claimed in claim 1, wherein the hoisting apparatus is provided with a telescopically extendable winch arm.

6. A load transportation system as claimed in claim 5, wherein the winch arm is telescopically extendable.

7. A load transportation system as claimed in claim 5, wherein the winch arm has a reach of at least 6.0 m from the edge of the floor.

8. A load transportation system as claimed in claim 1, wherein the hoisting apparatus has a Safe Working Load (SWL) of at least 3,000 kg.

9. A load transportation system as claimed in claim 1, wherein the maximum lifting height of the hoisting apparatus is at least 120 m.

10. A load transportation system as claimed in claim 1, wherein the maximum lifting speed of the hoisting apparatus is at least 25 m per minute.

11. A method of installing a load transportation system for use in the building construction industry, the method comprising the steps of:
(i) lifting a loading platform to an upper storey of a building under construction where a hoisting apparatus is to be installed;
(ii) temporarily installing the loading platform on said upper storey;
(iii) lifting a hoisting apparatus onto the loading platform;
(iv) moving the hoisting apparatus into the storey of the building and bracing it in position against the building structure;
(v) detaching the loading platform from the upper storey and lowering it to an underlying storey; and
(vi) removably installing the loading platform on the underlying storey such that it is moveable between an extended position in which it can extend beyond the edge of a floor of the underlying storey, and a retracted position.

12. A method of installing a load transportation system as claimed in claim 11, wherein steps (i) and (iii) and (v) are performed by a tower crane.

13. A method of installing a load transportation system as claimed in claim 11, wherein the method comprises the further step of using the hoisting apparatus to lift one or more further such loading platforms to one or more further underlying storeys and removably installing them thereon.

14. A method of installing a load transportation system as claimed in claim 11, wherein the method comprises the additional steps of detaching a loading platform from the underlying storey; using the hoisting apparatus to lift it to another underlying storey not having a loading platform; and removably reinstalling the loading platform on the new underlying storey.

15. A method of removing a load transportation system installed in accordance with the second aspect, the method comprising the steps of:
(i) attaching the hoisting apparatus to a loading platform on an underlying storey;
(ii) detaching the loading platform from the underlying storey;
(iii) using the hoisting apparatus to lower the loading platform to ground level;
(iv) repeating steps (i) to (iii) as required for all remaining underlying loading platforms;
(v) lifting a loading platform to the upper storey of the building where the hoisting apparatus is installed;
(vi) temporarily installing the loading platform on said upper storey;
(vii) releasing the hoisting apparatus from its braced position and moving it onto the loading platform;
(viii) lifting the hoisting apparatus from the loading platform and lowering it to ground level;
(ix) detaching the loading platform from the upper storey; and
(x) lowering the loading platform to ground level.

16. A method of removing a load transportation system as claimed in claim 15, wherein steps (v), (viii) and (x) are performed by a tower crane.
